(19) United States
(12) Patent Application Publication
(10) Pub. No.: US 2010/0054517 A1
(43) Pub. Date: Mar. 4, 2010

(54) Mounting Device for Mounting a Sound Pickup Device on an Object

(76) Inventor: Kun-Tien CHIANG, Rende Township (TW)

Correspondence Address: HANCOCK HUGHEY LLP, P.O. BOX 1208, SISTERS, OR, 97759, US

(21) Appl. No.: 12/204,077

(22) Filed: Sep. 4, 2008

(51) Int. Cl. H04R 1/02

(52) U.S. Cl. 381/368

(57) ABSTRACT

A mounting device is adapted for mounting a sound pickup device on an object, and includes a mounting unit, a shock absorbing unit, and a coupling unit. The mounting unit includes a mounting member that is adapted to be provided on the object and that has a top side, and a linking member that is disposed on the top side of the mounting member and that has top and bottom sides. The shock absorbing unit includes a resilient body that is disposed on the top side of the linking member and that has a top side. The coupling unit includes a coupling member that is disposed on the top side of the resilient body and that is adapted for connecting to the sound pickup device.

### BACKGROUND OF THE INVENTION

1. Field of the Invention

This invention relates to a mounting device, more particularly to a mounting device for mounting a sound pickup device on an object.

2. Description of the Related Art

A sound pickup device, such as a microphone, is a device that picks up sound and that cooperates with a speaker in order to reproduce the sound in an occasion such as a conference, a ceremony, or a show. A mounting device is used for mounting the sound pickup device on an object that is adjacent to a sound source. The object may be a music stand, a support column, a musical instrument, a platform, etc.

Presently, there is no shock-absorbing device installed on the mounting device or between the object and the sound pickup device. Therefore, when the object is subjected to shock due to a collision, the sound pickup device is vibrated as well because the shock is transferred to the sound pickup device through the mounting device incapable of dampening shock. Consequently, the sound pickup device picks up undesirable noise. The sound pickup device may be even damaged by stronger shock, thereby reducing the service life of the sound pickup device.

### SUMMARY OF THE INVENTION

The object of the present invention is to provide a mounting device that is suitable for mounting a sound pickup device on an object and that can overcome the aforesaid drawbacks of the prior art.

According to this invention, a mounting device is adapted for mounting a sound pickup device on an object, and includes a mounting unit, a shock absorbing unit, and a coupling unit. The mounting unit includes a mounting member that is adapted to be provided on the object and that has a top side, and a linking member that is disposed on the top side of the mounting member and that has top and bottom sides. The shock absorbing unit includes a resilient body that is disposed on the top side of the linking member and that has a top side. The coupling unit includes a coupling member that is disposed on the top side of the resilient body and that is adapted for connecting to the sound pickup device.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view of the first preferred embodiment of a mounting device for mounting a sound pickup device on an object according to this invention;

FIG. 2 is a fragmentary schematic sectional view to illustrate a fastener connecting the sound pickup device to a coupling member according to the first preferred embodiment;

FIG. 3 is another fragmentary schematic sectional view, to illustrate the fastener connecting the sound pickup device to the coupling member according to the first preferred embodiment;

FIG, 4 is a perspective view of the second preferred embodiment of the mounting device according to this invention;

FIG. 5 is a fragmentary schematic, sectional view to illustrate side members cooperatively holding the sound pickup device therebetween according to the second preferred embodiment;

FIG. 6 is another fragmentary schematic sectional view to illustrate the side members cooperatively holding the sound pickup device therebetween according to the second preferred embodiment;

FIG. 7 is a perspective view of the third preferred embodiment of the mounting device according to this invention; and

FIG. 8 is a perspective view of the fourth preferred embodiment of the mounting device according to this invention.

### DETAILED DESCRIPTION OF THE PREFERRED EMBODIMENTS

Before the present invention is described in greater detail, it should be noted that same reference numerals have been used to denote like elements throughout the specification.

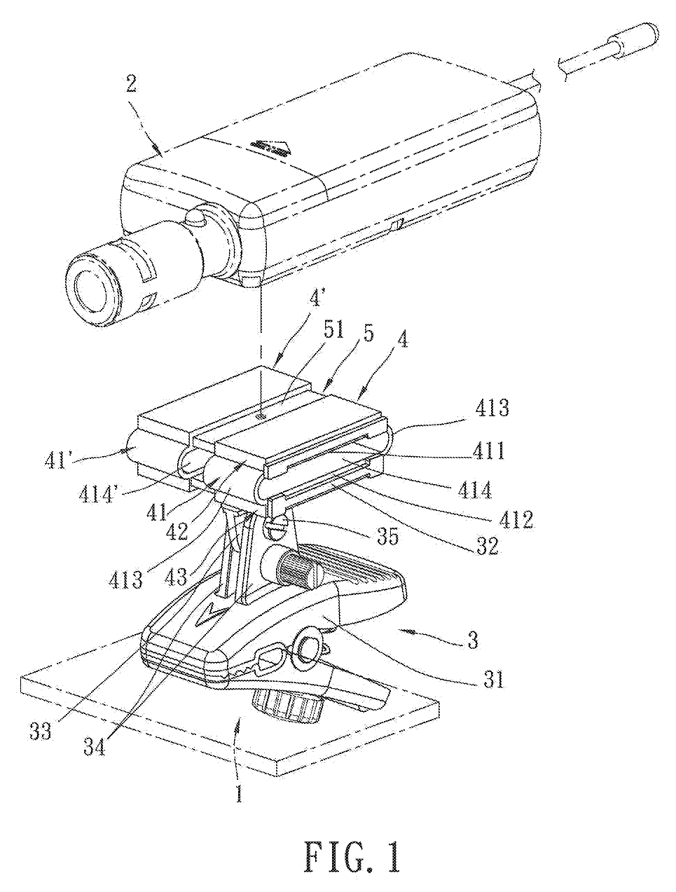

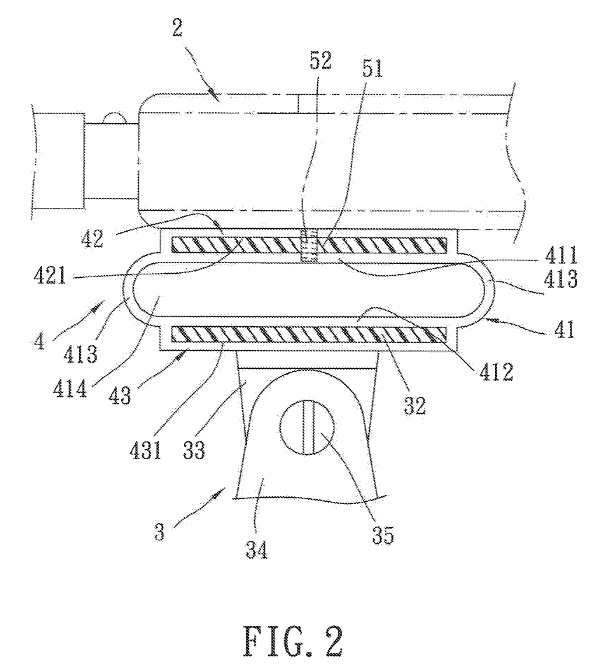

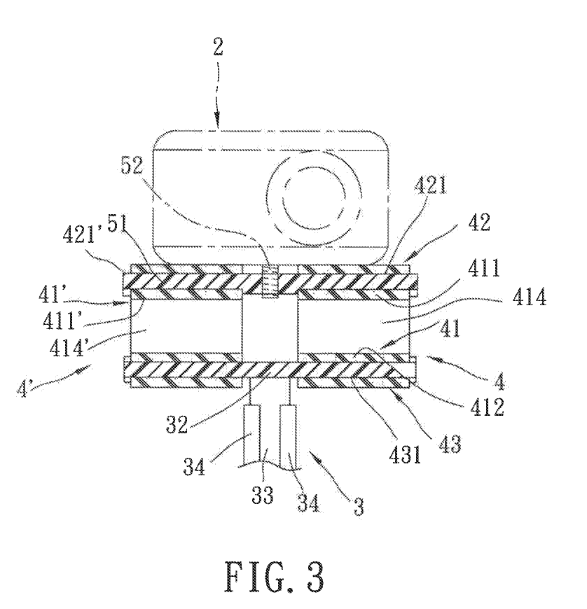

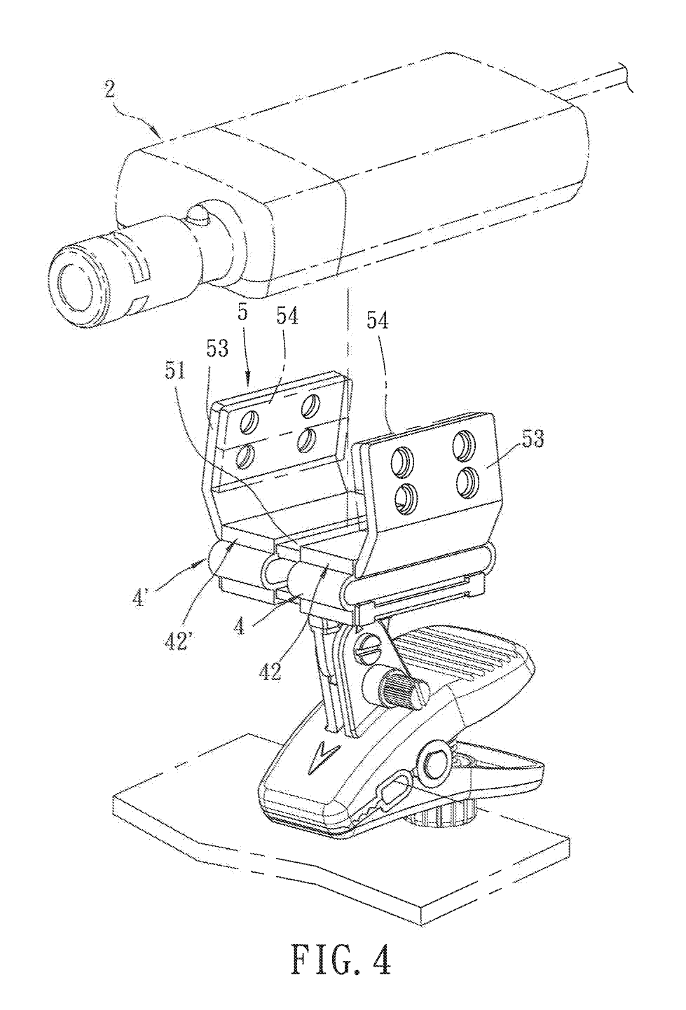

Referring to FIGS. 1, 2, and 3, the first preferred embodiment of a mounting device according to the present invention is adapted for mounting a sound pickup device 2 on an object 1 such as a music stand. While the sound pickup device 2 is a microphone according to this embodiment, the type of the microphone is not restricted to the one shown in FIG. 1. The mounting device includes a mounting unit 3, a first shock absorbing unit 4, and a coupling unit 5.

The mounting unit 3 includes a mounting member 31 that is adapted to be provided on the object 1 and that has a top side, and a linking member 32 that is disposed on the top side of the mounting member 31 and that has top and bottom sides. In this embodiment, the mounting member 31 is a clamping device, and the linking member 32 is a plate (see FIG. 1). Since the feature of the invention does not reside in the clamping device, further details of the same are omitted herein for the sake of brevity.

The mounting unit 3 further includes a swing plate 33 that has one end connected to the bottom side of the linking member 32 and that extends downwardly from the bottom side of the linking member 32, at least one wing plate 34 that has one end connected to the top side of the mounting member 31 and that extends upwardly from the top side of the mounting member 31, and a pivot unit 35 that connects pivotally the swing plate 33 to the wing plate 34 such that the swing plate 33 is repositionable at a desired angular orientation relative to the wing plate 34. Therefore, the linking member 32 connected to the swing plate 33 is repositionable at a desired angular orientation relative to the mounting member 31 by virtue of the swing plate 33.

In this embodiment, the mounting unit 3 includes two of the wing plates 34, each of which has one end connected to the top side of the mounting member 31 and extends upwardly from the top side of the mounting member 31. The swing plate 33 is disposed between the wing plates 34. The pivot unit 35 connects pivotally the swing plate 33 to the wing plates 34.

It should be noted herein that the swing plate 33, the wing plates 34, and the pivot unit 35 may be omitted in other embodiments of this invention. In such embodiments, the linking member 32 is connected directly to the mounting member 31.

The first, shock absorbing unit 4 includes a resilient body 41 that is disposed on the top side of the linking member 32 and that has a top side. The resilient body 41 is a one-piece body made of a flexible rubber material that has suitable hardness, and is capable of dampening shock. In this embodiment, the resilient body 41 of the first shock absorbing unit 4 is a hollow oval-shaped body and has a top wall 411 that has a top side, a bottom wall 412 that has a bottom side connected to the linking member 32, and two curved side walls 413 that interconnect the top wall 411 and the bottom wall 412 and that cooperate with the top wall 411 and the bottom wall 412 to define a deformable space 414.

The first shock absorbing unit 4 further includes a top shell 42 that extends upwardly and integrally from the top side of the top wall 411, that has a top side, and that cooperates with the top wall 421 to define a top through-hole 421, and a bottom shell 43 that extends downwardly and integrally from the bottom side of the bottom wall 412 and that cooperates with the bottom wall 412 to define a bottom through-hole 431. The linking member 32 is inserted into the bottom through-hole 431.

In this embodiment, the mounting device further includes a second shock absorbing unit 4′ including a resilient body 41′ that is disposed on the top side of the linking member 32 and that has a top side. The second shock absorbing unit 4′ is identical to the first shock absorbing unit 4 in structure, and is coupled to the linking member 32 in a manner similar to that described hereinabove in connection with the first shock absorbing unit 4. The, swing plate 33 is disposed between the first and second shock absorbing units 4,4′.

The coupling unit 5 includes a coupling member 51 that is disposed on the top sides of the resilient bodies 41,41′ of the first and second shock absorbing units 4,4′ and that is adapted for connecting to the sound pickup device 2.

More particularly, the coupling member 51 is a plate that is inserted into the top through-holes 421,421′ in the first and second shock absorbing units 4,4′, thereby connecting the top sides of the top walls 411,411′ of the first and second shock absorbing units 4,4′ to the coupling member 51.

It is noted herein that the second shock absorbing unit 4′ may be omitted in other embodiments of this invention. In further embodiments, a third shock absorbing unit (not shown) may be included depending on design requirements.

In this embodiment, the coupling unit 5 further includes at least one fastener 52, that is adapted for connecting the sound pickup device 2 to the coupling member 51 such that the sound pickup device 2 is secured to the top side of the top shell 42. For example, the fastener 52 may be a bolt that is installed on the sound pickup device 2 and that extends outwardly from the sound pickup device 2. The coupling member 51 may be formed with a screw hole that can be engaged threadedly with the bolt of the sound pickup device 2. As another example, the fastener 52 may be an individual screw connecting the sound pickup device 2 that has a screw hole therein and the coupling member 51 that is formed with a fastener hole. In yet another example, a fastening unit that has a first fastening component and a second fastening component may replace the fastener 52. The first fastening component is provided on the sound pickup device 2, and the second fastening component is provided on the coupling member 51. The first fastening component is a hook fastening component, and the second fastening component is a loop fastening component. It is noted that the first fastening component maybe a loop fastening component, and the second fastening component may be a hook fastening component in other examples. In a further example, the fastener 52 may be a belt that binds the sound pickup device 2 and the coupling member 51 together.

The object 1 is clamped by the mounting member 31 for mounting the sound pickup device 2 on the object 1 (see FIG. 1). When the object 1 is vibrated due to shock, the first and second shock absorbing units 4,4′ are able to dampen the shock that is transferred to the mounting device from the object 1 by virtue of the resiliency of the resilient bodies 41,41′. Stronger shock can be dampened because of the presence of the deformable space 414, 414′ in the first and second shock absorbing units 4,4′. Therefore, the sound pickup device 2 is not severely vibrated and picks up sound with minimal undesirable noise since the shock is not transferred upwardly to the coupling unit 5 from the object 1. Furthermore, the service life of the sound pickup device 2 is prolonged because the shock is not transferred to the sound pickup device 2.

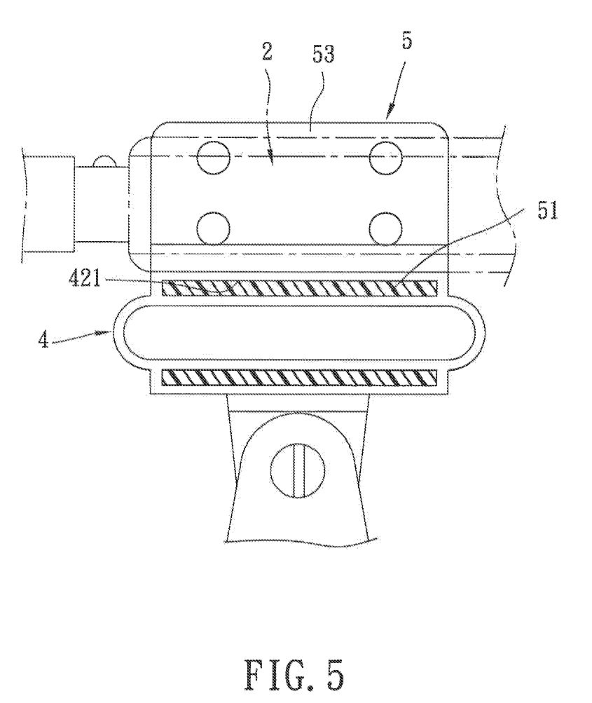

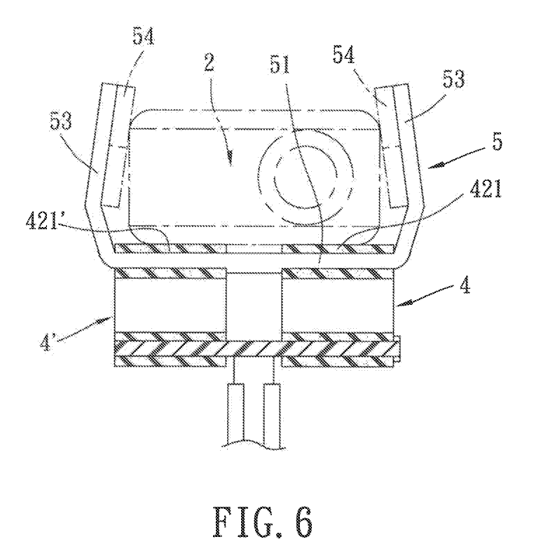

Referring to FIGS. 4, 5, and 6, the second preferred embodiment of the mounting device according to this invention is illustrated. The structure of this preferred embodiment is similar to that of the first preferred embodiment. The differences between the first and second preferred embodiments are described as follows.

The coupling member 51 of the coupling unit 5 is a plate that is inserted into the top through-holes 421,421′ and that has opposite sides extending outwardly of the top through-holes 421,421′. The coupling unit 5 further includes a pair of side members 53 that extend respectively and upwardly from the opposite sides of the coupling member 51, and that are adapted to cooperatively hold the sound, pickup device 2 therebetween on the top sides of the top shells 42,42′ of the first and second shock absorbing units 4,4′. The side members 53 have inner sides facing the sound pickup device 2 when the side members 53 cooperatively hold the sound pickup device 2 therebetween.

In this embodiment, the coupling unit 5 further includes a pair of cushions 54 that are disposed respectively on the inner sides of the side members 53, thereby enabling the side members 53 to hold the sound pickup device 2 more tightly.

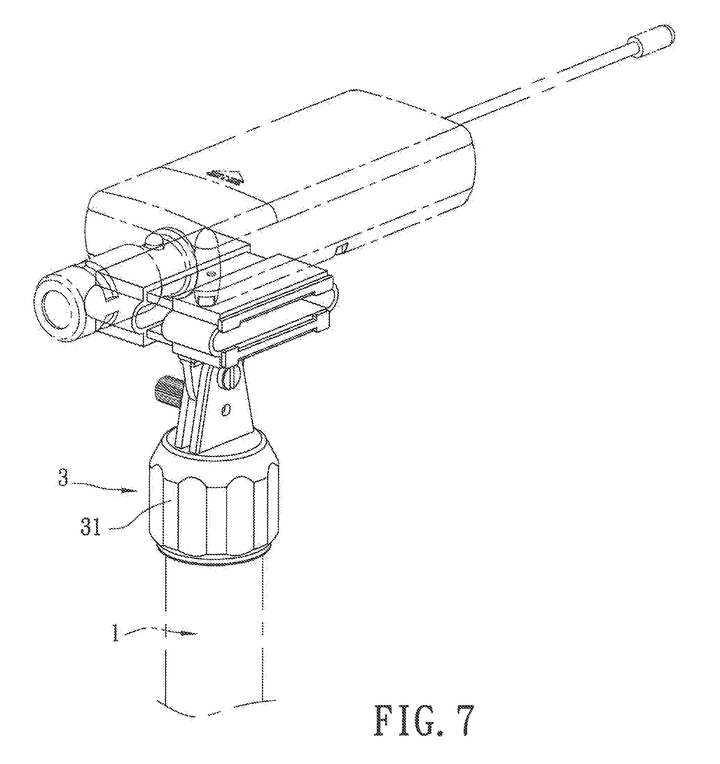

Referring to FIG. 7, the third preferred embodiment of the mounting device according to this invention is illustrated. The structure of this preferred embodiment is similar to the structures of the first and second preferred embodiments. The difference between this preferred embodiment and the preceding preferred embodiments is described as follows.

The mounting member 31 of the mounting unit 3 is a mounting sleeve that is adapted to be detachably sleeved on the object 1 such as a support column. Since the feature of the invention does not reside in the mounting sleeve, further details of the same are omitted herein for the sake of brevity.

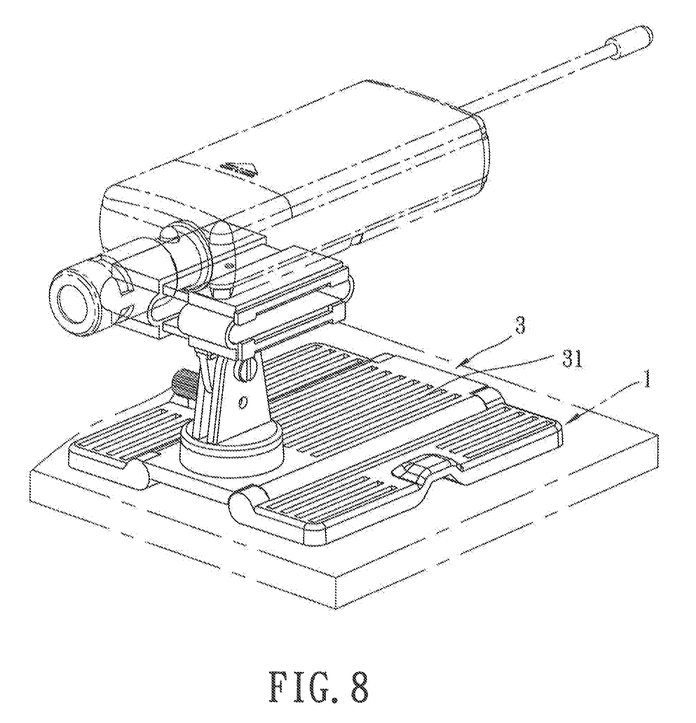

Referring to FIG. 8, the fourth preferred embodiment of the mounting device according to this invention is illustrated. The structure of this preferred embodiment is similar to the structures of the first, second, and third preferred embodiments. The difference between this preferred embodiment and the preceding preferred embodiments is described as follows.

The mounting member 31 of the mounting unit 3 includes a base member and a hook-and-loop fastening unit that is adapted to be provided between the base member and the object 1 for detachably positioning the base member on the object 1 such as a musical instrument or a platform.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A mounting device adapted for mounting a sound pickup device on an object, said mounting device comprising:
a mounting unit including a mounting member that is adapted to be provided on the object and that has a top side, and a linking member that is disposed on said top side of said mounting member and that has top and bottom sides;
a first shock absorbing unit including a resilient body that is disposed on said top side of said linking member and that has a top side; and
a coupling unit including a coupling member that is disposed on said top side of said resilient body and that is adapted for connecting to the sound pickup device.

2. The mounting device as claimed in claim 1, wherein said resilient body of said first shock absorbing unit is hollow and has a top wall that has a top side connected to said coupling member, a bottom wall that has a bottom side connected to said linking member, and two side walls that interconnect said top and bottom walls and that cooperate with said top and bottom walls to define a deformable space.

3. The mounting device as claimed in claim 2, wherein said first shock absorbing unit further includes a top shell that extends upwardly from said top side of said top wall, that has a top side, and that cooperates with said top wall to define a top through-hole, and a bottom shell that extends downwardly from said bottom side of said bottom wall and that cooperates with said bottom wall to define a bottom through-hole, said linking member being inserted into said bottom through-hole, said coupling member being inserted into said top through-hole.

4. The mounting device as claimed in claim 3, wherein:
said coupling member of said coupling unit is a plate that is inserted into said top through-hole; and
said coupling unit further includes at least one fastener that is adapted for connecting the sound pickup device to said coupling member such that the sound pickup device is secured to said top side of said top shell.

5. The mounting device as claimed in claim 3, wherein:
said coupling member of said coupling unit is a plate that is inserted into said top through-hole and that, has opposite sides extending outwardly of said top through-hole; and
said coupling unit further includes a pair of side members that extend respectively and upwardly from said opposite sides of said coupling member, and that are adapted to cooperatively hold the sound pickup device therebetween on said top side of said top shell.

6. The mounting device as claimed in claim 1, wherein said mounting member of said mounting unit is a clamping device that is adapted for clamping the object.

7. The mounting device as claimed in claim 1, wherein said mounting member of said mounting unit is a mounting sleeve that is adapted to be detachably sleeved on the object.

8. The mounting device as claimed in claim 1, wherein said mounting member of said mounting unit includes a base member and a hook-and-loop fastening unit that is adapted to be provided between said base member and the object for detachably positioning said base member on the object.

9. The mounting device as claimed in claim 1, wherein said mounting unit further includes a swing plate that has one end connected to said bottom side of said linking member and that extends downwardly from said bottom side of said linking member, at least one wing plate that has one end connected to said top side of said mounting member and that extends upwardly from said top side of said mounting member, and a pivot unit that connects pivotally said swing plate to said wing plate such that said swing plate is repositionable at a desired angular orientation relative to said wing plate.

10. The mounting device as claimed in claim 1, further comprising a second shock absorbing unit including a resilient body that is disposed on said top side of said linking member and that has a top side, said coupling member being disposed on said top sides of said resilient bodies of said first and second shock absorbing units.
